(19) United States
(12) Patent Application Publication
(10) Pub. No.: US 2022/0009060 A1
(43) Pub. Date: Jan. 13, 2022

(54) SERVICE TOOL INCLUDING TELESCOPICALLY CONNECTED HEX KEYS

(71) Applicant: Alberto Torres-Barry, Naples, FL (US)

(72) Inventor: Alberto Torres-Barry, Naples, FL (US)

(21) Appl. No.: 17/303,303

(22) Filed: May 26, 2021

Related U.S. Application Data
(60) Provisional application No. 62/705,685, filed on Jul. 10, 2020.

(51) Int. Cl. B25B 23/00; B25B 15/00

(52) U.S. Cl. CPC B25B 23/0007; B25B 15/008

(57) ABSTRACT

Generally, a service tool and method of using the service tool is disclosed. The service tool includes a first hex key having a first diameter size and defines a first cavity along a longitudinal length thereof. The service tool further includes a second hex key having a second diameter size smaller than the first diameter size, and the second hex key is designed to slidably translate within the first cavity of the first hex key. The service tool can, for example, be used to service a liquid line valve using the second hex key and a suction line valve using the first hex key, with the second hex key retracting into the first hex key when servicing the suction line valve.

### CROSS-REFERENCE TO RELATED APPLICATION

This application claims the benefit of priority of U.S. provisional application No. 62/705,685, filed Jul. 10, 2020, the contents of which are herein incorporated by reference.

### BACKGROUND OF THE INVENTION

The present invention relates to hex (also referred to as “hex”) key tools and, more particularly, to a tool that has a larger and smaller hex key telescopically connected to one another in order to open service valves without stripping the valve.

A hex key (also known as an Allen wrench or key wrench), is a tool known in the art having a hexagonal head used to turn or drive screws, bolts, and the like haying hexagonal-shaped receiving sockets. In general, the head of a hex wrench defines six contact surfaces that, in use, are inserted into a screw or a bolt's hexagonal-shaped socket. When operated, torque is applied to the hex key to turn the screw or the bolt.

Many suction line valves on condensing units are too shallow to allow a traditional 5/16″ hex key portion to reach deep enough in the suction valve so as to not strip it out when loosening or tightening the suction line valve. Further, because of the depth of the liquid line valve in the condensing unit, and the short length of a conventional 3/16″ hex key, stripping of the valves are too commonplace because the hex key does not adequately penetrate into the condensing unit. Because the lengths of all size hex keys of the hex key tool specifically configured, by necessity, to form the tool, the valves frequently get stripped because the required size is not long enough for the condensing unit application. This principle is true in other applications that require two different size hex keys.

As can be seen, there is a need for a tool that includes differing size hex keys telescopically connected to one another.

### SUMMARY OF THE INVENTION

In one aspect of the present invention, a service tool comprises: a first hex key having a first diameter size and defining a first cavity along a longitudinal length thereof; and a second hex key having a second diameter size smaller than the first diameter size and configured to slidably translate within the first cavity of the first hex key.

In another aspect of the present invention, a method for servicing a condensing unit comprises: providing service tool comprising: a first hex key having a first diameter size and defining a first cavity along a longitudinal length thereof; and a second hex key having a second diameter size smaller than the first diameter size and configured to slidably translate within the first cavity of the first hex key; inserting the second hex key in a liquid line valve; and rotating the service tool.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown exploded and in use with a liquid line valve and a suction line valve;

FIG. 2 is a cross-sectional view of the embodiment of the present invention, taken on line 2-2 of FIG. 1;

FIG. 3 is a cross-sectional view of the embodiment of the present invention, taken on line 3-3 of FIG. 1;

FIG. 4 is a cross-sectional view of the embodiment of the present invention, taken on line 4-4 of FIG. 1;

FIG. 5A is an exploded elevation view of the embodiment of the present invention, showing of first step of employing the smaller hex key;

FIG. 5B is a side elevation view of the embodiment of the present invention, showing a second step of employing the smaller hex key;

FIG. 6 is a side elevation view of the embodiment of the present invention, with the larger hex key and square body shown in cross-section to show inner workings of the embodiment;

FIG. 7A is an exploded elevation view of the embodiment of the present invention, similar to FIG. 5A, showing a first step in employing the larger hex key;

FIG. 7B is a side elevation view of the embodiment of the present invention, similar to FIG. 5B, showing a second step in employing the larger hex key;

FIG. 7C is a side elevation view of the embodiment of the present invention, showing a third step in employing the larger hex key, with full retraction of the smaller hex key; and

FIG. 8 is a side elevation view of the embodiment of the present invention, similar to FIG. 8, with the larger hex key and square body shown in cross-section to show inner workings of the embodiment.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, one embodiment of the present invention is a service tool. The service tool includes a first hex key having a first diameter size and defining a first cavity along a longitudinal length thereof, and further includes a second hex key having a second diameter size smaller than the first diameter size and configured to slidably translate within the first cavity of the first hex key.

According to one embodiment of the present invention, a smaller hex key portion (such as 3/16″) and larger hex key portion (such as 5/16″) may be provided on a tool to open two separate valves with the two sizes provided. To do so, the smaller hex key portion may operate a smaller valve/bolt size. When the larger hex key portion is need, the smaller hex key portion telescopically retracts within the larger hex key portion when inserted in the larger valve/bolt to allow the larger hex key portion to open the valve (or unscrew another mechanical fastener).

In the present exemplary embodiment, the smaller portion of the tool will telescopically retract when inserted in the valve to allow the larger portion of the tool to open a suction line valve without stripping it. When a liquid line valve is to be opened, the tool may be used, without retracting the smaller portion, to open that valve. Besides the present invention, no other tool retracts the smaller (e.g., 3/16″) hex key portion to allow the tool to open the larger (e.g., 5/16″) valve, free of stripping out the valve. By retracting the front/smaller end when opening the 5/16″ suction line, it becomes virtually impossible to strip out the valve. It will be appreciated by those having skill in the art that this principle may be applied to other size hex key portions where two size hex keys are needed for the same application without the need for switching tools.

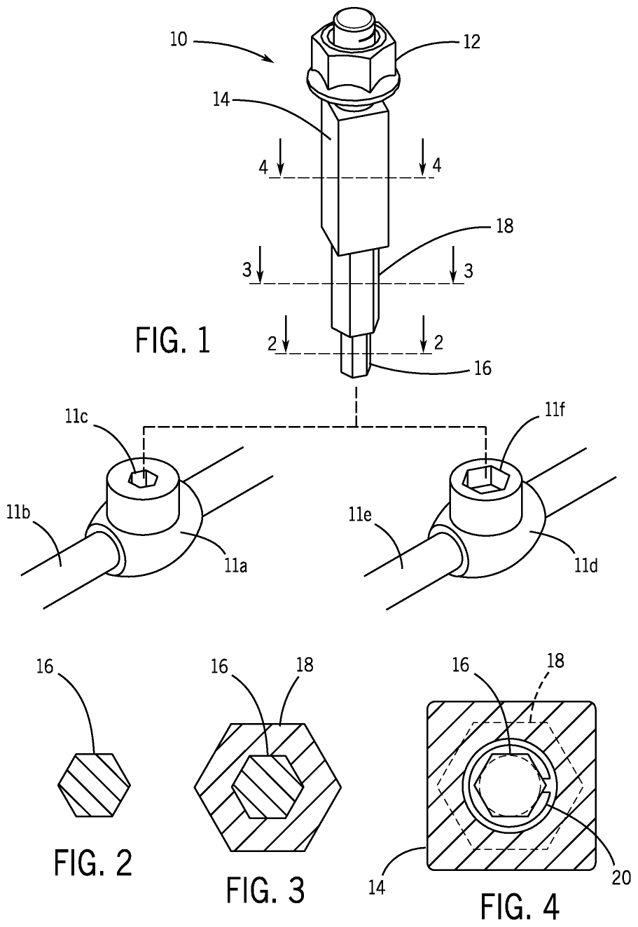

Referring now to FIG. 1, a service valve tool 10 is provided for use with a liquid line valve 11a and a suction line valve 11d. As shown in FIG. 1, the suction line valve 11a is provided along a liquid conduit 11b and includes a smaller hex socket 11c. As also shown in FIG. 1, the suction line valve 11d is provided along a suction conduit 11e and includes a larger hex socket 11f.

Making further reference to FIG. 1, the service valve tool 10 includes a nut (such as a flanged nut 12 or a thumb nut) that is threaded onto threads 12a of a set screw 24 (the flanged nut 12 and set screw 24 generally defining a coupling member), a middle body 14 (which, in certain embodiments, may be substantially square), a smaller hex key 16, and a larger hex key 18. The flanged nut 12 is configured such that it may be coupled to a service wrench to operate the service valve tool 10. A connecting portion 5 of the tool, in use, connects to a service wrench. In certain embodiments, the smaller hex key 16 may be 3/16 inch in size, while the larger hex key may be 5/16 inch in size.

A coil spring 22 (with a compressed position 22a shown in FIG. 8) is housed within a cavity in the middle body 14 and is fixedly coupled, at opposite ends, to the set screw 24 and an interior end of the smaller hex key 16 via a snap ring 20. While the middle body 14 is generally described as being distinct from the larger hex key 18, it will be appreciated that the middle body 14 may also be embodied as an extension of the larger hex key 18 (and is mainly used to delineate the section where the spring 22 translates).

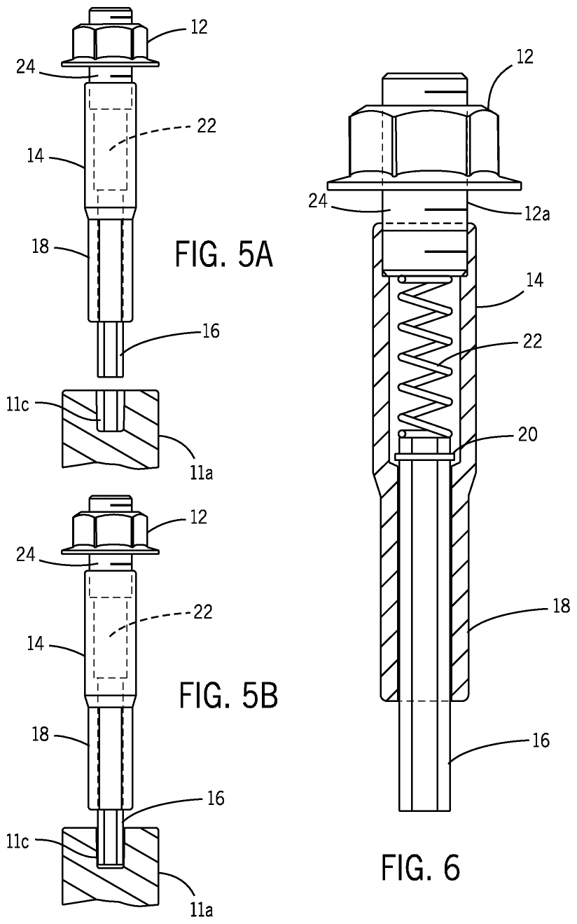

FIG. 6 illustrates a non-compressed state of the service valve tool 10. In this position, the smaller hex key 16 extends from a bottom end of the cavity in the middle body 14, through a cavity in the larger hex key 18 to extend past a bottom end of the larger hex key 18. The cavity in the larger hex key 18 is complementarily shaped/sized relative to the smaller hex key 16 so that the smaller hex key 16 does not rotate relative to the larger hex key 18, as shown in FIG. 3. As shown in FIGS. 5A and 5B, the smaller hex key 16 may be inserted into a liquid line valve 11a having a smaller hex socket 11c of the same diameter size as the smaller hex key 16. In use, the service valve tool 10 can then open or close the liquid line valve 11a.

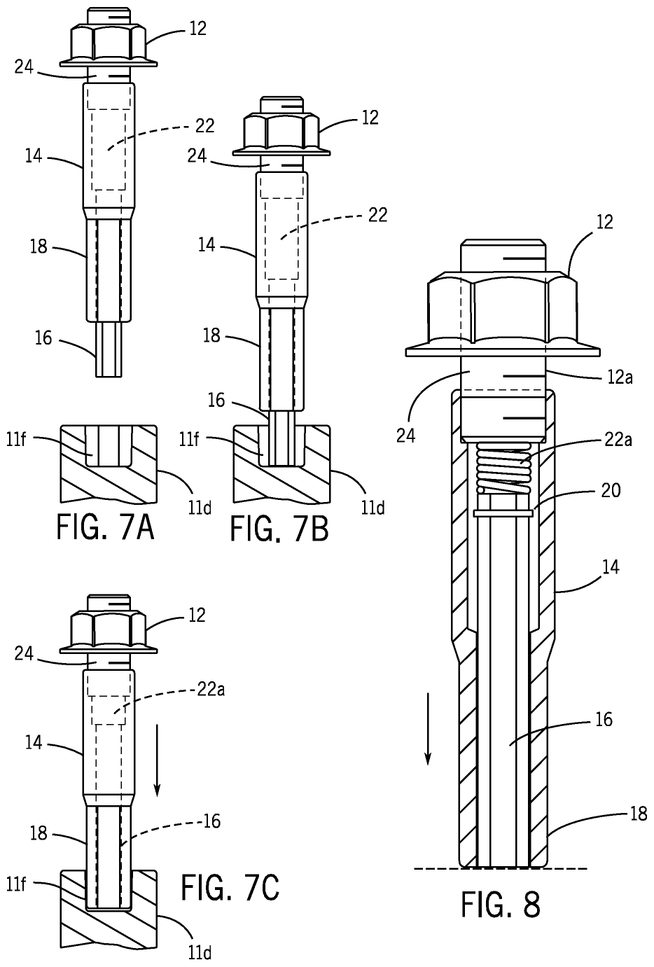

As shown, for example, in FIGS. 7A-8, the smaller hex key 16 is retractable when the larger hex key 18 is needed (for example when being inserted into a suction line valve 11d). As the service valve tool 10 is pressed into the larger hex socket 11f (which is the same size as the larger hex key 18), the smaller hex key 16 retracts partially into the cavity in the middle body 14 and compresses the spring 22 (see FIG. 8). When this occurs, a bottom surface of the smaller hex key 16 is substantially co-planar with a bottom surface of the larger hex key 18, and the larger hex key 18 can be used to open or close the suction line valve 11d.

When the service valve tool 10 is removed from the suction line valve 11d, the smaller hex key 16 is urged back outwards by the spring 22 until the snap ring 20 (or other appropriate structure) abuts a ledge that is formed between the cavity of the middle body 14 and the cavity in the larger hex key 18 (the cavity of the middle body 14 having a larger diameter/width than the cavity in the larger hex key 16). Because of the spring action, the smaller hex key 16 will always be biased to an operable position but can be selectively retracted when the larger hex key 18 is needed.

To summarize one way in the service valve tool 10 may be used: a user connects the tool 10 to a service wrench. The user then places the tool 10 in a liquid line valve 11a and proceed to turn the wrench counterclockwise until the valve is fully open. Then, the tool 10 is removed from the liquid line valve 11a and placed in the suction line valve 11d, with the user putting downward pressure on the valve, causing the smaller hex key 16 to telescopically retract into the larger hex key 18 and the middle body 14 of the tool 10. Then, the larger hex key 18 can be used to open the suction line valve 11d be rotating the wrench counterclockwise.

In other embodiments, the service valve tool 10 may be designed in a way such that the larger hex key 18 is the hex key that retracts rather than the smaller hex key 16. Further, the flange nut 12 and the set screw 24 may be embodied as a single piece with a spring-loaded ball bearing for attachment to a service wrench.

To make embodiments of the present invention, various methods may be used to make the key portions, such as with a computer numeric control (CNC) machine, via metal injection molding, milling, or a combination thereof. Because the larger hex key 18 and middle body 14 defines an opening at a top side thereof, the smaller hex key 16 can be dropped therewithin. The spring 22 is then housed within the cavity in the middle body 14, and the set screw 24 may be threaded into the top end of the middle body 14 to retain it in place.

The present invention has been described in terms of exemplary embodiments solely for the purpose of illustration. Persons skilled in the art will recognize from this description that the invention is not limited to the embodiments described but may be practiced with modifications and alterations limited only by the spirit and scope of the appended claims. It will also be appreciated that terms such as “lower”, “bottom”, “top”, and “upper” are merely used to describe the invention in the context of the illustrations, and is not intended to place any implied limitations on orientation of the invention (e.g., the service tool may be used in the opposite direction as illustrated, which would result in a “bottom end” becoming the “top end”). Similarly, the terms “larger” and “smaller” are used to delineate between diameter sizes of the respective hex keys, with the larger key having a larger diameter than the smaller key, and do not require a particular size unless specifically claimed.

In the following claims, any labelling of elements, limitations, steps, or other parts of a claim (for example, first, second, etc., (a), (b), (c), etc., or (i), (ii), (iii), etc.) is only for purposes of clarity, and are not to be interpreted as suggesting any sort of ordering or precedence of the claim parts so labelled. If any such ordering or precedence is intended, it will be explicitly recited in the claim or, in some instances, it will be implicit or inherent based on the specific content of the claim. To further aid the USPTO and any readers of any patent issued on this application, it is additionally noted that there is no intent any of the appended claims to invoke paragraph (f) of 35 U.S.C. § 112 as it exists on the date of filing hereof unless the words “means for” or “step for” are explicitly used in the particular claim.

What is claimed is:

1. A service tool comprising:
a first hex key having a first diameter size and defining a first cavity along a longitudinal length thereof; and
a second hex key having a second diameter size smaller than the first diameter size and configured to slidably translate within the first cavity of the first hex key.

2. The service tool of claim 1, further comprising a middle body integral with the first hex key, the middle body defining a second cavity generally colinear with the first cavity.

3. The service tool of claim 2, further comprising a spring disposed in the second cavity and coupled to the second hex key, the spring being configured to bias a second hex key end of the second hex key away from a first hex key end of the first hex key.

4. The service tool of claim 3, wherein the second hex key is operable between an extended position, where the second hex key end is distal the first hex key end, and a retracted position, where the second hex key end is substantially flush with the first hex key end.

5. The service tool of claim 1, further comprising a coupling member connected to a middle body end of the middle body, the coupling member being configured to detachably connect to a service wrench.

6. The service tool of claim 5, further comprising a spring disposed in the second cavity and coupled to the second hex key and the coupling member, the spring being configured to bias a second hex key end of the second hex key away from a first hex key end of the first hex key.

7. The service tool of claim 2, wherein a first opening width is smaller than a second opening width.

8. The service tool of claim 7, wherein an inner second hex key end is retained in the second cavity and is prevented from translating into the first cavity.

9. A method for servicing a condensing unit, the method comprising:
providing service tool comprising:
a first hex key having a first diameter size and defining a first cavity along a longitudinal length thereof; and
a second hex key having a second diameter size smaller than the first diameter size and configured to slidably translate within the first cavity of the first hex key;
inserting the second hex key in a liquid line valve; and
rotating the service tool.

10. The method of claim 9, further comprising:
inserting the second hex key in a suction line valve;
pushing the service tool such that the second hex key slidably translates until a second hex key end of the second hex key is substantially flush with a first hex key end of the first hex key; and
rotating the service tool.
